(19) United States
(12) Patent Application Publication
(10) Pub. No.: US 2002/0176519 A1
(43) Pub. Date: Nov. 28, 2002

(54) Coarse frequency offset estimation

(76) Inventors: Alain Chiodini, Mountain View, CA (US); John Reagan, Santa Clara, CA (US); Srinivas Lingam, San Jose, CA (US)

Correspondence Address: GLENN PATENT GROUP, 3475 EDISON WAY, SUITE L, MENLO PARK, CA, 94025, US

(21) Appl. No.: 09/802,609

(22) Filed: Mar. 8, 2001

(51) Int. Cl. H04L 27/14

(52) U.S. Cl. 375/324

(57) ABSTRACT

An orthogonal frequency division multiplexing (OFDM) receiver which digitally estimates and corrects for frequency offset and demodulates quadrature amplitude modulated (QAM) signals transmitted in the 5 GHz frequency band embodies the current invention. Possible modulation types include binary phase shift keying (BPSK), quadrature phase shift keying (QPSK), 16-QAM, 64-QAM, (and 256-QAM in future standard enhancements). During the so-called short-preamble, the first few basic constituents are deliberately skipped. Then every 2.4 μs, a 1.6 μs duration sequence is collected until three such sequences are collected. Because the same waveform can be safely assumed to being repeated during all three sequences, any differences amongst the sequences are directly related to the frequency-offset error. The solution is set-up as a simultaneous-equation mathematical problem with a single unknown variable, a pseudo-rank of one. The maximum eigenvector is determined and used in the definition of an objective function. This objective function is computed for several possible steering vectors corresponding to different frequency offsets. The index of the maximum of the objective function serves an index into a pre-stored table of possible complex exponentials at differing frequencies. The frequency correcting cisoid is created by repeatedly multiplying the last element in the cisoid by all previous values to in essence double the length of the correcting cisoid. This method results in minimum table storage requirements and is quite well suited to vector processing.

### BACKGROUND OF THE INVENTION

1. Technical Field

The invention relates to physical layer (PHY) digital signal processing for use in processors developed for wireless local area networks (LAN's), and more particularly to wireless LAN's based on orthogonal frequency division multiplexing (OFDM) in the license-free national information structure (U-NII) radio spectrum bands in the United States and generally conforming to IEEE Specification 802.11a.

2. Description of the Prior Art

Local area networks (LAN's) have traditionally been interconnected by twisted-wire pairs and shielded cables. However, there are several deficiencies of traditional LAN's, the main being restricted mobility. In contrast, a whole class of untethered computing has emerged which uses complex modulation and coding to achieve high-speed data rates. The IEEE 802.11a standard, herein “802.11a”, specifies, among other things, the physical layer (PHY) entity for an orthogonal frequency division multiplexing (OFDM) system with data payload communication capabilities of 6,9,12,18,24,36,48, and 54 Mb/s. The 802.11a standard specifies RF transmission in the 5.15-5.25, 5.25-5.35, and 5.725-5.825 GHZ unlicensed national information structure (U-NII) bands.

Typically, the IEEE communication standards specify the transmit bit-stream in addition to performance specifications, RF emissions requirements, etc. The wireless transmission medium inherently introduces some unique impairments (not present in traditional LAN's) to the transmitted signal which must be mitigated in the remote receiver station. These impairments include signal fading, multi-path reflections, base- and remote-unit oscillator mismatch introduced frequency offset, timing misalignment, and timing synchronization. In addition, there are RF hardware limitations such as receiver 10 imbalance and phase noise that must be mitigated as well. As such, the mitigation of such effects falls under the category of baseband digital signal processing. To assist the remote unit in mitigating these effects, a known training sequence is usually embedded into the transmit bit stream; this occurs at the expense of bandwidth. Of course, the same problems occur in the upstream direction (remote station transmitting to the base station), but it suffices to discuss the downstream digital signal processing.

In this disclosure, one such digital signal processing method, coarse frequency estimation, is outlined. This processing block digitally estimates the oscillator mismatch between the base- and remote-station and corrects for it in subsequent data demodulation. Typical voltage-controlled temperature-compensated crystal oscillators (VCTCXO) used in wireless communications have a ±20 (parts-per-million) ppm error. At 5 GHz (5000 MHz), this translates to an error of ±100 kHz at each end, or ±200 kHz in combination. With OFDM modulation, a frequency error of 3% of the inter-carrier frequency spacing is the maximum tolerable frequency error.

The transmission scheme in 802.11a is bursty. This means that the receivers must digitally process the training sequence to mitigate the undesired signal impairments each time a burst commences. This means that it is desirable for the processing blocks to be as robust and computationally efficient as possible.

The quality of carrier frequency-offset estimation must be such that the relative error between actual and estimated values does not exceed three percent of the frequency spacing between consecutive sub-carriers, e.g. 9.375 kHz. To reach this target precision, the 802.11a PHY specification recommends that frequency offset estimation be carried out into two successive stages, a coarse and fine frequency estimation stage. Coarse and fine estimates must be derived from the processing of the short and long preambles respectively. See, IEEE-802.11a-1999, §17.3.3. For short, these are called the “short preamble” and the “long preamble.”

Frequency offset errors must be removed for a receiver to track the transmitted signal and demodulate it properly. A conventional method exists to remove such offset which involves a control loop which feeds a frequency error signal back to a VCTCXO to slowly correct the oscillator mismatch. C&S Technology (Korea) has announced a wireless-LAN modem-chip for IEEE-802.11a applications (see http://cnstec.com/e-html/products/products-1-2-4.htm). Such uses an automatic frequency control (AFC) clock recovery circuit to correct frequency offset errors. However, due to the relatively short time span of the training sequence and the loop bandwidth of the control loop may result in inaccurate frequency correction, The method described herein does not use AFC circuitry. Rather, it estimates the existing frequency offset and instead of correcting for it with an AFC loop in an analog fashion, it constructs a frequency correcting cisoid at a frequency that is negative to the estimated frequency offset and uses this in subsequent digital signal processing and demodulation.

### SUMMARY OF THE INVENTION

Orthogonal frequency division multiplexing (OFDM) receiver embodiments of the invention demodulate quadrature amplitude modulated (QAM) signals transmitted in the 5 GHz frequency band and digitally correct for frequency offset errors in their digital signal processing (DSP) units. Modulation types include binary phase shift keying (BPSK), quadrature phase shift keying (QPSK), 16-QAM, 64-QAM, (and 256-QAM in future standard enhancements). During the short preamble, the first few constituents are deliberately skipped (the short preamble consists of 10 repetitions of a 16 sample sequence; a constituent is one 16 sample sequence). Then every 2.4 μs, a 1.6 μs-duration sequence is collected until three such sequences are collected. The way these three sequences are collected ensures that they represent the same waveform. Now, in the presence of a frequency offset, these sequences are phase offset with respect to one another (the second one with respect to the first one and the third one with respect to the second one are phase offset with the same value which directly relates to the frequency offset error). Once the frequency offset error is determined the estimate is used in subsequent digital signal processing.

### BRIEF DESCRIPTION OF THE DRAWINGS

FIG. 1 is a functional block diagram of an OFDM radio-transceiver embodiment of the invention;

FIG. 2 is a diagram representing the sampling of the short preamble used in training sequences for the physical layer (PHY) of a wireless local area network (LAN) conforming to the IEEE-802.11a specification; and

FIG. 3 is a diagram representing the sampling of the short preamble used in training sequences for the physical layer (PHY) of a wireless local area network (LAN) conforming to the IEEE-802.11a specification according to an alternate embodiment of the invention.

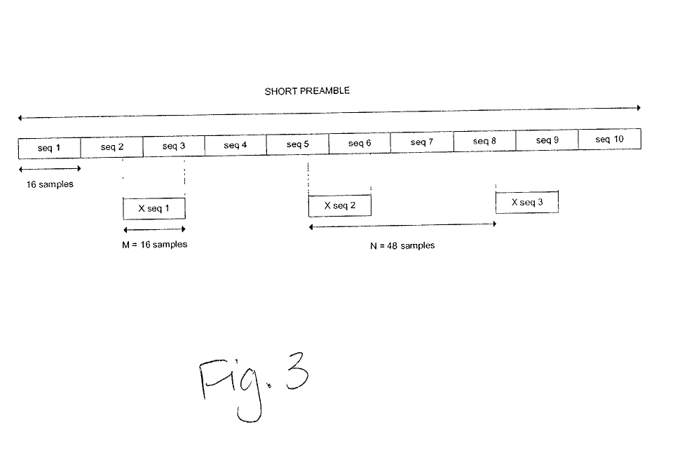

### DETAILED DESCRIPTION OF THE INVENTION

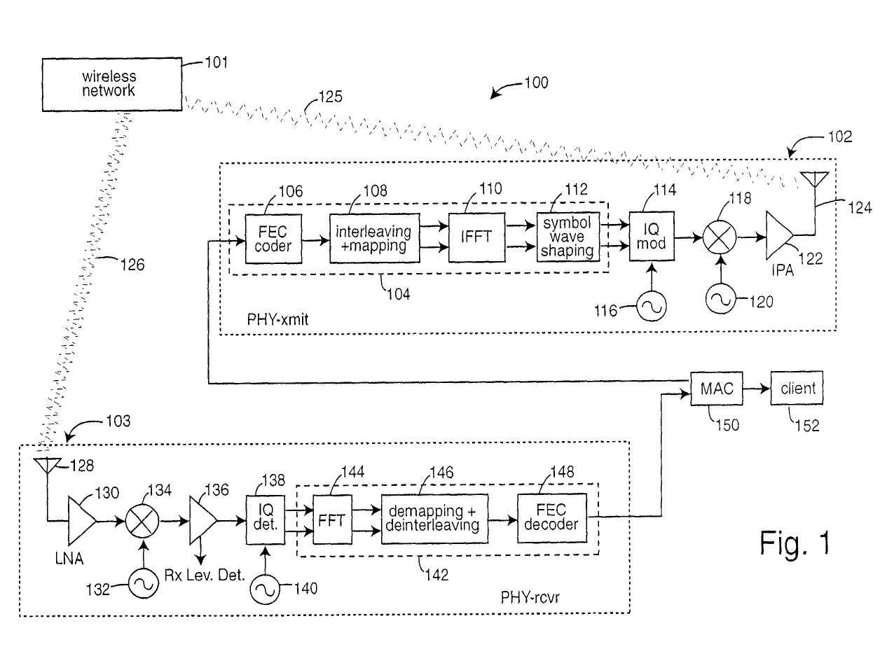

FIG. 1 illustrates a wireless local area network (LAN) embodiment of the invention, and is referred to herein by the general reference numeral 100. Such, wireless LAN is preferably based on orthogonal frequency division multiplexing (OFDM), and quadrature amplitude modulated (QAM) of signals transmitted in the license-free 5 GHz frequency band. Modulation types include binary phase shift keying (BPSK), quadrature phase shift keying (QPSK), 16-QAM, 64-QAM, (and 256-QAM in future standard enhancements). The wireless LAN 100 typically includes a wireless network 101 connected to the Internet, a PHY-transmitter 102, and a PHY-receiver 103. Such units all conform to the IEEE-802.11a specification for a physical layer (PHY) interface in a wireless local area network which allows mobile clients. The transmitter 102 comprises a digital signal processor (DSP) 104 which implements a forward error correction (FEC) coder 106, an interleaving and mapping process 108, an inverse fast Fourier transform processor 110, and a symbol wave shaper 112. The DSP 104 outputs in-phase (I) and quadrature-phase (Q) signals that are input to an IQ modulator 114 driven by a local oscillator 116. The modulated output is sent to a mixer 118 for upconversion to the 5 GHz band. A second local oscillator 120 provides the necessary carrier frequency. A high power amplifier (HPA) 122 drives a transmitter antenna 124. A radio up-link 125 is received by the wireless network 101. In general, the transmitter 102 can be implemented with conventional methods and components.

The receiver 103 receives a radio down-link 126 that is typically transmitted in bursts. Each burst is begun with a training sequence, e.g. a short and long preamble. The receiver 103 includes a receiver antenna 128 followed by a low-noise amplifier (LNA) 130. A local oscillator 132 and a first mixer 134 produce an intermediate frequency (IF). An automatic gain control (AGC) amplifier 136 smoothes out signal-strength variations and drives an IQ-detector 138. A second local oscillator 140 provides the carrier necessary to derive the I and Q samples. In all presently preferred embodiments of the invention, no automatic frequency control (AFC) clock recovery is needed because any frequency offset errors are corrected in later digital processing. A receiver-DSP 142 comprises a fast Fourier transform process 144, a demapping and deinterleaving process 146, and an FEC decoder 148. The receiver-DSP 142 further includes the necessary digital logic needed for carrier frequency offset determination and correction.

According to the IEEE-802.11a PHY specification, the frequency-offset estimation error must not exceed three percent of the adjacent sub-carrier channel spacing, e.g. 9.375 kHz. The specification therefore recommends that frequency offset estimation be carried out into two successive stages, e.g. a coarse estimation followed by a fine estimation. Such estimates are respectively derived from the processing of the so-called short and long preambles. This disclosure is limited to the coarse estimation of frequency offset using the short preamble. The estimation of the coarse frequency offset is the first operation to be performed once an incoming packet has been detected. In preferred embodiments, the coarse frequency offset operation precedes any other such operations as synchronization, i.e. determination of the boundary between short and long preambles; in other words, acquisition of a timing reference, timing misalignment estimation, i.e. intra-baud timing offset acquisition or equalization, i.e. determination of the transmission channel impulse response.

The QAM encoding of the transmitter signal causes symbols to be decoded in ways that are affected by the carrier frequency offset error. Presently preferred embodiments of the invention take advantage of the fact that the short preamble repeats the same sequence ten times in succession. On the transmitter side, the short preamble is generated by taking the inverse Fourier transform of a predefined 64-sample complex sequence (frequency domain) whose non-zero values could be regarded as a QPSK signal (of course, no information is embedded into it). The resulting signal (time domain) corresponds to the repetition of a basic constituent (four times) and appending this signal to itself one time and a half generates the rest of the short preamble. Implementation-wise though, no inverse Fourier transform is computed because the entire short preamble is stored in a lookup table. The same principle applies to the generation of long preamble, except that the long preamble is obtained through a BPSK-like signal and contains two and a half basic constituents). If we accept any other phenomena, such as multipath or distortion, then any phase difference observed between short preamble constituents can be attributed to the carrier frequency offset. Therefore, if three equally spaced sequences (having equal length) are extracted from the short preamble then the solution to a simultaneous equation that includes all three sequences yields their common frequency offset error. Mathematically, the problem reduces to the calculation and subsequent processing of a covariance matrix R characterized by a pseudo-rank of one (the rank of a matrix M is the largest number of columns that constitute a linearly independent set; in our case, since three identical (but time delayed) sequences are used to calculate R, the rank is ideally one).

Method embodiments of the invention are based on an eigenvector decomposition of a covariance matrix. This is computed from three equally spaced 16-sample sequences extracted from the short preamble. And that is followed by a maximization of a cost function derived from the maximum eigenvector.

Described mathematically, let s₁(n),s₂(n),s₃(n) designate the column vectors associated with the three extracted sequences mentioned above. The covariance matrix is given by:

R=Z^{H}Z

With:

$$Z = \begin{matrix}[ {s}_{1} ( n ) & {s}_{2} ( n ) & {s}_{3} ( n ) ]\end{matrix}$$

$${s}_{1} ( n ) = {σ}_{1} ( n ) + {η}_{1} ( n ) \\ {s}_{2} ( n ) = {σ}_{2} ( n ) + {η}_{2} ( n ) \\ {s}_{3} ( n ) = {σ}_{3} ( n ) + {η}_{3} ( n ) \\ {σ}_{1} ( n ) = {Ae}^{j2 π \frac{v}{{F}_{s}} n + j Φ ( n ) + j ϕ} \\ {σ}_{2} ( n ) = {Ae}^{j2 π \frac{v}{{F}_{s}} ( n + N ) + j Φ ( n + N ) + j ϕ} = {ⅇ}^{j2 π \frac{v}{{F}_{s}} N} {σ}_{1} ( n ) \\ {σ}_{3} ( n ) = {Ae}^{j2 π \frac{v}{{F}_{s}} ( n + 2 N ) + j Φ ( n + 2 N ) + j ϕ} = {ⅇ}^{j2 π \frac{v}{{F}_{s}} N} {σ}_{2} ( n ) = {ⅇ}^{j4 π \frac{v}{{F}_{s}} N} {σ}_{1} ( n )$$

Expanding (1),

$$R = ⌊ \begin{matrix}{MA}^{2} + {γ}_{11}^{M} & {MA}^{2} {ⅇ}^{j2 π \frac{v}{{F}_{s}} N} + {γ}_{1.2}^{M} & {MA}^{2} {ⅇ}^{j4 π \frac{v}{{F}_{s}} N} + {γ}_{1.3}^{M} \\ {MA}^{2} {ⅇ}^{- j2 π \frac{v}{{F}_{s}} N} + {γ}_{1.2}^{- M} & {MA}^{2} + {γ}_{2.2}^{M} & {MA}^{2} {ⅇ}^{j2 π \frac{v}{{F}_{s}} N} + {γ}_{2.3}^{M} \\ {MA}^{2} {ⅇ}^{- j4 π \frac{v}{{F}_{s}} N} + {γ}_{1.3}^{- M} & {MA}^{2} {ⅇ}^{- j2 π \frac{v}{{F}_{s}} N} + {γ}_{2.3}^{- M} & {MA}^{2} + {γ}_{3.3}^{M}\end{matrix} ⌋$$

$$\text{With:}$$

$${γ}_{k \cdot l}^{M} = {\sum }_{n = 1}^{M} {η}_{k} ( n ) {η}_{l}^{\hat{}} ( n )$$

In the absence of noise, R is rank 1 and decomposes as follows:

$$\begin{matrix}R = {MA}^{2} [ \begin{matrix}1 & {ⅇ}^{j2 π \frac{v}{{F}_{s}} N} & {ⅇ}^{j2 π \frac{v}{{F}_{s}} N} \\ {ⅇ}^{- j2 π \frac{v}{{F}_{s}} N} & 1 & {ⅇ}^{j2 π \frac{v}{{F}_{s}} N} \\ {ⅇ}^{- j4 π \frac{v}{{F}_{s}} N} & {ⅇ}^{- j2 π \frac{v}{{F}_{s}} N} & 1\end{matrix} ] \\ = {MA}^{2} [ \begin{matrix}1 \\ {ⅇ}^{- j2 π \frac{v}{{F}_{s}} N} \\ {ⅇ}^{- j4 π \frac{v}{{F}_{s}} N}\end{matrix} ] [ \begin{matrix}1 & {ⅇ}^{j2 π \frac{v}{{F}_{s}} N} & {ⅇ}^{j4 π \frac{v}{{F}_{s}} N}\end{matrix} ] \\ = λ {a}^{H} ( v ) a ( v )\end{matrix}$$

Given,

$$\begin{matrix}f ( μ ) = w ( μ ) {Rw}^{H} ( μ ) \\ = w ( μ ) {a}^{H} ( v ) a ( v ) {w}^{H} ( μ ) \\ = {\vert w ( μ ) {a}^{H} ( v ) \vert}^{2} \\ = {\vert 1 + {ⅇ}^{j2 π - \frac{μ v}{{F}_{s}} N} + {ⅇ}^{j4 π \frac{μ - v}{{F}_{s}} N} \vert}^{2}\end{matrix}$$

with,

$$w ( μ ) = ⌊ \begin{matrix}1 & {ⅇ}^{j 2 π \frac{μ}{{F}_{s}} N} & {ⅇ}^{j4 π \frac{μ}{{F}_{s}} N}\end{matrix} ⌋$$

Because R is positive definite, f(μ)≧0∀μ∈R. Inspection shows that f exhibits one strong maximum (when μ=v) and several depressed secondary peaks.

In practical implementations, the received signals are adversely affected by additive white Gaussian noise and multi-path interference (not to mention co-channel interference). The determining of R's maximum eigenvector is a first step. A simple and cost-effective iterative method embodiment of the invention can quickly converge to the solution, e.g. within two iterations typically for a pseudo rank one matrix.

For example, expressing R and any vector x∈C^{K} using the eigenvector basis,

$$\begin{matrix}R = {\sum }_{n = 1}^{K} {λ}_{n} {a}_{n}^{H} {a}_{n} \\ x = {\sum }_{m = 1}^{K} {γ}_{m} {a}_{m}\end{matrix}$$

The vector matrix products are computed by,

$$\begin{matrix}{x}_{1} = {x}_{0} R = {\sum }_{m = 1}^{K} {γ}_{m} {a}_{m} {\sum }_{n = 1}^{K} {λ}_{n} {a}_{n}^{H} {a}_{n} \\ = {\sum }_{m = 1}^{K} {\sum }_{n = 1}^{K} {γ}_{m} {λ}_{n} ( {a}_{m} {a}_{n}^{H} ) {a}_{n} \\ = {\sum }_{m , n = 1}^{K} {γ}_{m} {λ}_{n} {δ}_{mn} {a}_{n} \\ = {\sum }_{m = 1}^{K} {γ}_{m} {λ}_{m} {a}_{m}\end{matrix}$$

$$\begin{matrix}{x}_{2} = {x}_{1} R = {\sum }_{m = 1}^{K} {γ}_{m} {λ}_{m} {a}_{m} {\sum }_{n = 1}^{K} {λ}_{n} {a}_{n}^{H} {a}_{n} \\ = {\sum }_{m = 1}^{K} {\sum }_{n = 1}^{K} {γ}_{m} {λ}_{m} {λ}_{n} ( {a}_{m} {a}_{n}^{H} ) {a}_{n} \\ = {\sum }_{mn = 1}^{K} {γ}_{m} {λ}_{m} {λ}_{n} {δ}_{m , n} {a}_{n} \\ = {\sum }_{m = 1}^{K} {γ}_{m} {λ}_{m}^{2} {a}_{m}\end{matrix}$$

This iterative operation is repeated up to xₖ,

$$\begin{matrix}{x}_{k} = {x}_{k - 1} R = {\sum }_{m = 1}^{K} {γ}_{m} {λ}_{m}^{k - 1} {a}_{m} {\sum }_{n = 1}^{K} {λ}_{n} {a}_{n}^{H} {a}_{n} \\ = {\sum }_{m = 1}^{K} {\sum }_{N = 1}^{K} {γ}_{m} {λ}_{m}^{k - 1} {λ}_{n} ( {a}_{m} {a}_{n}^{H} ) {a}_{n} \\ = {\sum }_{mn = 1}^{K} {γ}_{m} {λ}_{m}^{k - 1} {λ}_{n} {δ}_{m , n} {a}_{n} \\ = {\sum }_{m = 1}^{K} {γ}_{m} {λ}_{m}^{k} {a}_{m}\end{matrix}$$

For the sake of simplicity, R is assumed to have pseudo rank one. This means that the spectrum of eigenvalues is such that λ₁=λ₁>>λ₂λ₃, . . . , λₖ. Then xₖ rapidly converges to λ₁^{k}a₁ as k increases.

Recall that the maximum eigenvector has the following format:

$$w ( μ ) = [ \begin{matrix}1 & {ⅇ}^{j2 π \frac{μ}{{F}_{s}} N} & {ⅇ}^{j4 π \frac{μ}{{F}_{s}} N}\end{matrix} ]$$

The frequency offset is calculated by maximizing an objective function. The objective function, f(μ)is computed on a grid of μ, where μ ranges from −208.33 kHz to 208.33 kHz. The objective function is defined to be:

$$\vec{q} ( v ) = [ \begin{matrix}1 \\ {ⅇ}^{j2 π \frac{v}{{F}_{s}} N} \\ {ⅇ}^{j4 π \frac{v}{{F}_{s}} N}\end{matrix} ]$$

$$f ( u ) = {‖ \vec{w} ( μ ) \vec{q} ( v ) ‖}^{2}$$

Clearly, when μ=v, then a maximum of f(μ) occurs. The resolution of this search grid depends on the requirements. For the presently preferred application, the required resolution is approximately +/−10 kHz. If this search grid is split into 64 equal regions, the final resolution in theory is half of the bin width (=416.66 kHz/64) or 3.255 kHz, which is more than sufficient. However, due to noise and other imperfections, it has been seen that partitioning the 416.66 kHz search region into 64 sub-regions does not provide sufficient resolution to determine the peak to within the required resolution. As such, a method is proposed which achieves the resolution with minimum extra computation. It is described as follows:

The pre-stored steering vectors, or q(μ), are defined where μ is defined as 0:208.33 kHz in 64 equal increments. The sign of the imaginary part of the second component of the computed dominant eigenvector is analyzed. This value is exp(j*2*π*(μ/Fs)*N). This is enough information to determine whether the frequency offset is positive or negative. If the sign of the imaginary part of the second component of the computed dominant eigenvector is negative, the pre-stored steering vectors are conjugated. The objective function is then computed as normal and the estimated frequency is estimated and then, finally, the sign is swapped depending on the sign of the imaginary part of the second component of the computed dominant eigenvector. One advantage of this is that the search resolution is now effectively double that of approach before and there is enough margin built in to account for peak shifting due to imperfections. This extra step, which takes minimal cycles to implement, completely eliminates the need for a fine-frequency estimation stage which reduces MIPS. Clearly, to achieve the same frequency resolution, one could double the resolution on the grid to 128, but this would require substantially more MIPS.

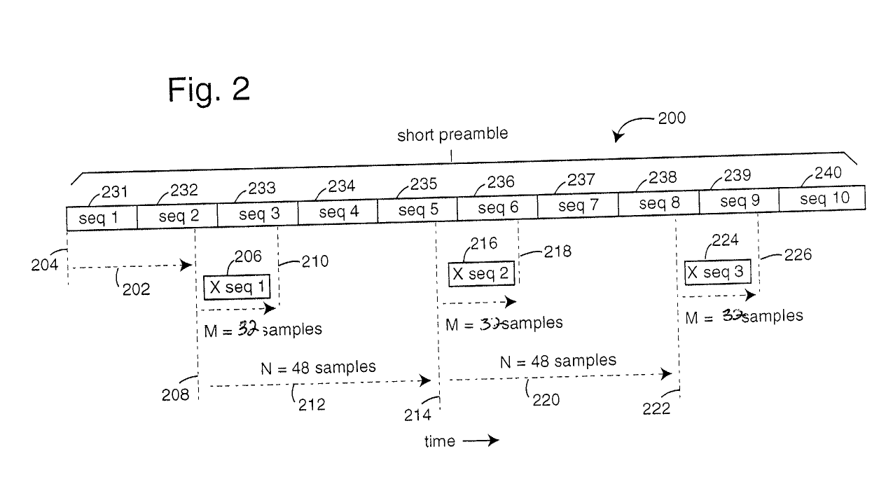

FIG. 2 represents a short preamble 200 used in training sequences for the physical layer (PHY) of a wireless local area network (LAN) conforming to the IEEE-802.11a specification. Such is sampled three times after a short delay time 202 from a packet transmission start 204. A first measurement 206 typically spans thirty-two sample times from a start time 208 to an end time 210. A first period delay 212 is typically forty-eight sample times until a next start time 214. A second measurement 216 is collected thirty-two more sample times until an end time 218. Similarly, a second period delay 220 is typically forty-eight sample times until a next start time 222. A third measurement 224 is collected thirty-two more sample times until an end time 226. In the absence of any noise and distortions, measurements 206, 216, and 224 differ only by their relative phase offset (the frequency offset information is embedded into these phase offsets as explicitly showed in formula (2) above) if a set of symbols 231-240 are all ten the same. All presently preferred embodiments of the invention rely on this observation and use digital signal processing methods to correct the common frequency offset that has been computed in a wireless local area network.

Alternate Embodiment For Coarse Frequency Offset Estimation

In an alternate embodiment, the coarse frequency offset is based on Capon's minimum variance estimator. This alternate embodiment improves performance when there are one or more co-channel interferers. This embodiment differs from the preferred embodiment in that the cost function used to estimate the coarse frequency offset is directly derived from Capon's estimator. Note though that the way the signal is extracted from the short preamble stays exactly the same as in the preferred embodiment, i.e. one collects three equally spaces (48 samples) equal-length sequences, each comprising 32 samples in the current implementation and not 16 as actually shown.

Let s₁(n),s₂(n),s₃(n) designate the column vectors associated with the three extracted sequences mentioned above. The covariance matrix is given by:

R=Z^{H}Z

With:

$$Z = [ \begin{matrix}{s}_{1} ( n ) & {s}_{2} ( n ) & {s}_{3} ( n )\end{matrix} ]$$

$${s}_{1} ( n ) = {σ}_{1} ( n ) + {η}_{1} ( n )$$

$${s}_{2} ( n ) = {σ}_{2} ( n ) + {η}_{2} ( n )$$

$${s}_{3} ( n ) = {σ}_{3} ( n ) + {η}_{3} ( n )$$

$${σ}_{1} ( n ) = A {ⅇ}^{j2 π \frac{v}{{F}_{s}} n + j Φ ( n ) + j ϕ}$$

$${σ}_{2} ( n ) = A {ⅇ}^{j2 π \frac{v}{{F}_{s}} ( n + N ) + j Φ ( n + N ) + j ϕ} = {ⅇ}^{j2 π \frac{v}{{F}_{s}} N} {σ}_{1} ( n )$$

$$\begin{matrix}{σ}_{3} ( n ) = A {ⅇ}^{j2 π \frac{v}{{F}_{s}} ( n + 2 N ) + j Φ ( n + 2 N ) + j ϕ} \\ = {ⅇ}^{j 2 π \frac{v}{{F}_{s}} N} {σ}_{2} ( n ) \\ = {ⅇ}^{j 4 π \frac{v}{{F}_{s}} N} {σ}_{1} ( n ) .\end{matrix}$$

The embodiment is as follows:

in the absence of any noise and interferers, it is easy to see from the formulas above that the frequency-offset information is embedded into the phase of σ₂ and σ₃ in the form of a relative phase offset (2πv/FₛN and 4πv/FₛN respectively) relatively to σ₁.

Now, if one or more interferers are present (it is assumed that the S over I ratio is greater than, e.g. 10 dB), signal and interferers respective short preambles may largely overlap time-wise. Moreover, the interferers are very likely to be characterized by a different carrier offset. If the task is to combine the extracted sequences s₁, s₂ and s₃ so as to best estimate σ₁ (idealized signal of interest) then we would have to find a way to eliminate the unwanted contribution of interferers through appropriate weighting. This could be achieved through the use of Capon's minimum variance estimator. This estimator is well known in array processing. In fact, because of the particular way we collect s₁, s₂ and s₃, the problem of estimating the frequency offset is similar to that of estimating the direction of arrival (DOA) of a signal impinging on a 3-antenna array (outputting three signals). Once the DOA has been determined, Capon's estimator allows the derivation of the transmit weights that minimize the total power output by the array. In particular, nulls are steered towards interferers while constraining the gain of the array in the direction of the signal of interest to be constant. The receive weights are simply deduced from the transmit weights by taking the conjugate of the latter. Now, since our task is simply to estimate the frequency offset i.e. the equivalent of the DOA in array processing. We do not seek here to combine s₁, s₂ and s₃ into one single signal, we just need one by-product of Capon's estimator, namely the distribution of the received power versus the DOA, i.e. the frequency offset in our case.

Where:

$$f ( μ ) = \frac{1}{g ( μ )} = \frac{1}{w ( μ ) {R}^{- 1} {w}^{H} ( μ )}$$

$$\text{Where:}$$

$$w ( μ ) = [ \begin{matrix}1 & {ⅇ}^{j 2 π \frac{μ}{{F}_{s}} N} & {ⅇ}^{j 4 π \frac{μ}{{F}_{s}} N}\end{matrix} ]$$

is a steering vector. Hence, the value of the frequency offset, i.e. μ is simply derived through the minimization of g(μ) (our new cost function).

The minimization of g(μ) is conducted in a way very similar to the way the cost function is maximized in the preferred embodiment,. i.e. by spanning a grid of μ values through the use of an array of predefined steering vectors. The only difference lies in the fact that R⁻¹ must be computed. Remember that there is no need to invert R in the preferred embodiment. Whereas in the preferred embodiment the computational complexity of the cost function was greatly reduced through the explicit computation of the maximum eigenvector (intermediate step), it is out of question to proceed likewise here for the simple reason that the pseudo rank of R⁻¹ is assumed to be greater or equal than 2 as we assume that one or more interferers are present.

Performance-wise, this alternate estimator performs much better than the preferred one when one or more co-channel interferers are present (its complexity is much higher though). Nevertheless, the latter shall be preferred in the absence of interferers.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for frequency-offset error determination, comprising the steps of:
receiving a string composed of a same basic constituent repeated ten times, where a basic constituent is generated from a sequence, defined in the frequency domain, containing QPSK-like modulated elements;
sampling said string to collect a plurality of measurements each including two of said basic constituents;
accounting for all measured differences amongst said plurality of samples as being solely attributable to a common frequency-offset error; and
correcting for said common frequency-offset error in later digital signal processing.

2. The method of claim 1, wherein:
the step of sampling includes skipping a first few of said repeating QPSK symbols before a first measurement is taken.

3. The method of claim 1, wherein:
the step of sampling includes measuring said string of repeating QPSK-like modulated elements three times to obtain s₁(n), s₂(n), and s₃(n), and
the step of accounting sets up for solution a matrix,
R=Z^{H}Z with,
$$Z = [ \begin{matrix}{s}_{1} ( n ) & {s}_{2} ( n ) & {s}_{3} ( n )\end{matrix} ]$$
$${s}_{1} ( n ) = {σ}_{1} ( n ) + {η}_{1} ( n )$$
$${s}_{2} ( n ) = {σ}_{2} ( n ) + {η}_{2} ( n )$$
$${s}_{3} ( n ) = {σ}_{3} ( n ) + {η}_{3} ( n )$$
$${σ}_{1} ( n ) = A {ⅇ}^{j2 π \frac{v}{{F}_{s}} n + j Φ ( n ) + j ϕ}$$
$${σ}_{2} ( n ) = A {ⅇ}^{j2 π \frac{v}{{F}_{s}} ( n + N ) + j Φ ( n + N ) + j ϕ} = {ⅇ}^{j2 π \frac{v}{{F}_{s}} N} {σ}_{1} ( n )$$
$$\begin{matrix}{σ}_{3} ( n ) = A {ⅇ}^{j2 π \frac{v}{{F}_{s}} ( n + 2 N ) + j Φ ( n + 2 N ) + j ϕ} \\ = {ⅇ}^{j 2 π \frac{v}{{F}_{s}} N} {σ}_{2} ( n ) \\ = {ⅇ}^{j 4 π \frac{v}{{F}_{s}} N} {σ}_{1} ( n )\end{matrix}$$
and that can be expanded to,
$$R = ⌊ \begin{matrix}{MA}^{2} + {γ}_{1.1}^{M} & {MA}^{2} {ⅇ}^{j 2 π \frac{v}{{F}_{s}} N} + {γ}_{1.2}^{M} & {MA}^{2} {ⅇ}^{j 4 π \frac{v}{{F}_{s}} N} + {γ}_{13}^{M} \\ {MA}^{2} {ⅇ}^{- j 2 π \frac{v}{{F}_{s}} N} + {γ}_{1.2}^{- M} & {MA}^{2} + {γ}_{2 , 2}^{M} & {MA}^{2} {ⅇ}^{j 2 π \frac{v}{{F}_{s}} N} + {γ}_{23}^{- M} \\ {MA}^{2} {ⅇ}^{- j 4 π \frac{v}{{F}_{s}} N} + {γ}_{1.3}^{- M} & {MA}^{2} {ⅇ}^{- j 2 π \frac{v}{{F}_{s}} N} + {γ}_{2.3}^{- M} & {MA}^{2} + {γ}_{33}^{M}\end{matrix} ⌋$$
with:
$${γ}_{k \cdot l}^{M} {\sum }_{n = 1}^{M} {η}_{k} ( n ) {η}_{\hat{l}} ( n )$$
wherein, in the absence of noise, R is rank 1 and decomposes as,
$$R = {\sum }_{n = 1}^{K} {λ}_{n} {a}_{n}^{H} {a}_{n} \\ - x = {\sum }_{m = 1}^{K} {γ}_{m} {a}_{m} .$$

4. The method of claim 3, wherein:
the step of accounting recognizes any received signals is adversely affected by additive white Gaussian noise and multi-path interference, and determines R's maximum eigenvector in a first step followed by an iterative method with two iterations for a pseudo rank one matrix, and generally conforms to, expressing R and any vector x∈C^{K} using the eigenvector basis,
$$R = {\sum }_{n = 1}^{K} {λ}_{n} {a}_{n}^{H} {a}_{n}$$
$$x = {\sum }_{m = 1}^{K} {γ}_{m} {a}_{m}$$
wherein, the vector matrix products are computed by,
$$\begin{matrix}{x}_{1} = {x}_{0} R = {\sum }_{m = 1}^{K} {γ}_{m} {a}_{m} {\sum }_{n = 1}^{K} {λ}_{n} {a}_{n}^{H} {a}_{n} \\ = {\sum }_{m = 1}^{K} {\sum }_{n = 1}^{K} {γ}_{m} {λ}_{n} ( {a}_{m} {a}_{n}^{H} ) {a}_{n} \\ = {\sum }_{m , n = 1}^{K} {γ}_{m} {λ}_{n} {δ}_{mn} {a}_{n} \\ = {\sum }_{m = 1}^{K} {γ}_{m} {λ}_{m} {a}_{m}\end{matrix}$$
$$\begin{matrix}{x}_{2} = {x}_{1} R = {\sum }_{m = 1}^{K} {γ}_{m} {λ}_{m} {a}_{m} {\sum }_{n = 1}^{K} {λ}_{n} {a}_{n}^{H} {a}_{n} \\ = {\sum }_{m = 1}^{K} {\sum }_{n = 1}^{K} {γ}_{m} {λ}_{m} {λ}_{n} ( {a}_{m} {a}_{n}^{H} ) {a}_{n} \\ = {\sum }_{m , n = 1}^{K} {γ}_{m} {λ}_{m} {λ}_{n} {δ}_{m , n} {a}_{n} \\ = {\sum }_{m = 1}^{K} {γ}_{m} {λ}_{m}^{2} {a}_{m}\end{matrix}$$
and this iterative operation is repeated up to xₖ,
$$\begin{matrix}{x}_{k} = {x}_{k - 1} R = {\sum }_{m = 1}^{K} {γ}_{m} {λ}_{m}^{k - 1} {a}_{m} {\sum }_{n = 1}^{K} {λ}_{n} {a}_{n}^{H} {a}_{n} \\ = {\sum }_{m = 1}^{K} {\sum }_{n = 1}^{K} {γ}_{m} {λ}_{m}^{k - 1} {λ}_{n} ( {a}_{m} {a}_{n}^{H} ) {a}_{n} \\ = {\sum }_{m , n = 1}^{K} {γ}_{m} {λ}_{m}^{k - 1} {λ}_{n} {δ}_{m , n} {a}_{n} \\ = {\sum }_{m = 1}^{K} {γ}_{m} {λ}_{m}^{k} {a}_{m} .\end{matrix}$$

5. The method of claim 3, wherein:
the step of accounting assumes R to have pseudo rank one, and the spectrum of eigenvalues is such that λ₁−λ₁>>λ₂,λ₃, . . . , xₖ rapidly converge to λ₁^{k}a₁ as k increases.

6. The method of claim 1, further comprising the steps of:
computing f(μ) for sixty-four equally spaced values of p ranging from 0 to 208.33 kHz once a maximum eigenvector is available; and identifying a bulky peak which provides \hat{v}, the frequency offset estimate.

6. The method of claim 1, further comprising the steps of:
determining the sign of the imaginary part of the second component of the dominant eigenvector;
based upon the sign of the imaginary part of the second component of the dominant eigenvector, conjugate (or not) 64 pre-stored steering vectors which span possible frequency offsets from 0 to 208.33 kHz;
computing an objective function, f(υ) over requency offset in the range of 0 to 208.33 kHz; when μ=v (true frequency offset), then a maximum of occurs;
finding anthe index of the maximum of f(μ);
using this index as an element into a pre-stored lookup table consisting of
$${ⅇ}^{j2 π ( \frac{{μ}_{I}}{{F}_{s}} )}$$
for all μ, from 0 to 208.33 kHz in 64 increments; where single values of the complex exponential are stored for all positive frequency offsets;
let an index of the maximum of f(μ)=j;
then, a value retrieved from the table is
$${ⅇ}^{j2π ( \frac{{μ}_{j}}{{F}_{s}} )} ;$$
based upon a sign of the imaginary part of a second component of a dominant eigenvector, conjugate this value to get a proper starting point for a frequency-correcting cisoid;
wherein remaining elements of said frequency-correcting cisoid are generated as follows:
$${ⅇ}^{j2π ( \frac{{μ}_{j}}{{F}_{s}} )}$$
is retrieved from a table and stored to memory at memory location X;
loading a resulting value from memory, multiplied with itself, producing
$${ⅇ}^{j2π ( \frac{{μ}_{j}}{{F}_{s}} ) 2} ;$$
storing a resulting value to memory location X+1;
(vector) loading the two values of the correction cisoid from memory location X into the processor;
wherein a last value of this vector is multiplied by the entire vector to produce next samples in a correction cisoid;
storing these two values to memory location X+2.
$$[ {ⅇ}^{j2π ( \frac{{μ}_{j}}{{F}_{s}} ) 3} {ⅇ}^{j2π ( \frac{{μ}_{j}}{{F}_{s}} ) 4} ] = {ⅇ}^{j2π ( \frac{{μ}_{j}}{{F}_{s}} ) 2} * [ {ⅇ}^{j2π ( \frac{{μ}_{j}}{{F}_{s}} )} {ⅇ}^{j2π ( \frac{{μ}_{j}}{{F}_{s}} ) 2} ] ;$$
Reloading this vector into the processor starting at memory location X with length=4; and repeating this procedure 4 more times to obtain a correction cisoid.
